(19) United States
(12) Patent Application Publication
(10) Pub. No.: US 2015/0121245 A1
(43) Pub. Date: Apr. 30, 2015

(54) METHOD, SYSTEM AND NON-TRANSITORY COMPUTER-READABLE STORAGE MEDIUM FOR DISPLAYING PERSONALIZED INFORMATION ON DIGITAL OUT OF HOME

(71) Applicant: Feltmeng Inc., Taipei City (TW)

(72) Inventors: Hsin-Jen Huang, Taipei City (TW); Zhi-Hong Zhu, Taipei City (TW); Ju-Fen Chang, New Taipei City (TW); Hung-Chan Chai, Taipei City (TW)

(73) Assignee: Feltmeng Inc., Taipei City (TW)

(21) Appl. No.: 14/062,902

(22) Filed: Oct. 25, 2013

(51) Int. Cl. G06F 3/0481; G06F 3/0484

(52) U.S. Cl. CPC G06F 3/0481; G06F 3/0484
USPC 715/745

(57) ABSTRACT

A method of displaying personalized information on a digital out of home (DOOH) includes receiving location tagging information of a user; and displaying a picture related to the location tagging information on the DOOH when a location of the location tagging information complies with the location of the DOOH or a location within or near a viewing area of the DOOH.

### BACKGROUND OF THE INVENTION

1. Field of the Invention

The present invention relates to a method, system and non-transitory computer-readable storage medium for displaying personalized information on a digital out of home (DOOH), and more particularly, to a method, system and non-transitory computer-readable storage medium capable of displaying location tagging content on the DOOH, where the location tagging content corresponds to an individual on a social network.

2. Description of the Prior Art

With the advancement of electronic information transmission and displaying technologies, digital out of homes (DOOHs) are widely used for distributing information. Digital signages of the DOOHs are usually installed in public areas where crowds of people gather. The digital signages are capable of playing rich video and text content on large-size screens so that crowds can watch the digital signage at the same time; in other words, the digital signages “narrowcast” to the crowds. Since the audience watches the content of the DOOH together, they may easily influence each other. For example, when seeing a large number of people standing and looking at something, a pedestrian passing by may also stop and take a look at it (to figure out what happened).

The characteristics of “narrowcasting” and “crowd gathering” of the DOOHs make this type of medium a superior tool for advertising. Because of certain technical limitations, however, most advertisements on the DOOHs are confined to predefined videos and images, which are normally played in turn repeatedly. The effectiveness of such one-way dissemination is limited. Moreover, although the DOOHs have the characteristics of “narrowcasting”, the advertisements played thereof are often “commercial-oriented” (rather than “content-oriented”). People will quickly tire of watching them, and may eventually ignore them completely.

In recent years, social networking platforms (e.g. Facebook, Twitter, etc.) have become increasingly popular. The social networking platforms allow personal content to be transmitted selectively to those who may be interested via apps or browsers in mobile phones or tablets. Such social networking services (SNS) also provide check-in functionality to allow a user to check in at a specific location and share the location information with the user's friends. The user may also tag friends and check messages left by friends in relation to the check-in information. “Check-in” refers to tagging or marking the location of the user, for example at a shop. In this situation, “check-in” not only allows a user to share details of their life with friends, but also provides an opportunity for the owner of the shop to provide special prices to encourage the check-in, in order to increase the shop exposure.

Common landmarks or places for check-in are usually famous restaurants or tourist attractions, and the check-in functionality are only limited to sharing on a social networking platform. There is therefore a need to provide a system which combines the “check-in” functionality of social networking with the commercial advertisements played on DOOHs, in order to get more attention from users and achieve more effective marketing.

### SUMMARY OF THE INVENTION

It is therefore an objective of the present invention to provide a method, system and non-transitory computer-readable storage medium capable of displaying the location tagging content of a user in a social network on a DOOH. The check-in functionality of the social network can therefore be integrated into the content broadcasting of DOOH. The personalized check-in content can be played on an outdoor video wall, and related pictures can also be shared on social networking platforms simultaneously. Through this method, people will take more notice of both the advertising and check-in, which further achieves effective marketing.

The present invention discloses a method of displaying personalized information on a DOOH. The method comprises receiving location tagging information of a user; and displaying a picture related to the location tagging information on the DOOH when a location of the location tagging information complies with the location of the DOOH or a location within or near a viewing area of the DOOH.

The present invention further discloses a system for displaying personalized information for a DOOH. The system comprises a memory, for storing the location of the DOOH; a processor; and a storage medium, having a program executable by the processor to perform the following steps: receiving location tagging information of a user; and displaying a picture related to the location tagging information on the DOOH when a location of the location tagging information complies with the location of the DOOH or a location within or near a viewing area of the DOOH.

The present invention further discloses a non-transitory computer-readable storage medium having a program that can be executed by a processor to perform a method of displaying personalized information on a DOOH. The method comprises receiving location tagging information of a user; and displaying a picture related to the location tagging information on the DOOH when a location of the location tagging information complies with the location of the DOOH or a location within or near a viewing area of the DOOH.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network environment according to an embodiment of the present invention.

FIG. 2 is a schematic diagram of a process according to an embodiment of the present invention.

FIG. 3 is a schematic diagram of selecting the check-in location according to an embodiment of the present invention.

FIG. 4A illustrates a photo taken at a check-in location of the user in the DOOH.

FIG. 4B illustrates a scene picture including the video wall of the DOOH and its peripheral environment.

FIG. 5A is a schematic diagram of a DOOH displaying a spot photo combined with a commercial advertisement according to an embodiment of the present invention.

FIG. 5B is a schematic diagram of the photo and the scene picture delivered on the social networking platform when the user checks in according to an embodiment of the present invention.

FIG. 6A is a schematic diagram of another DOOH displaying a spot photo combined with a commercial advertisement according to an embodiment of the present invention.

FIG. 6B is a schematic diagram of the photo and scene picture delivered on the social networking platform when the user checks in according to an embodiment of the present invention.

### DETAILED DESCRIPTION

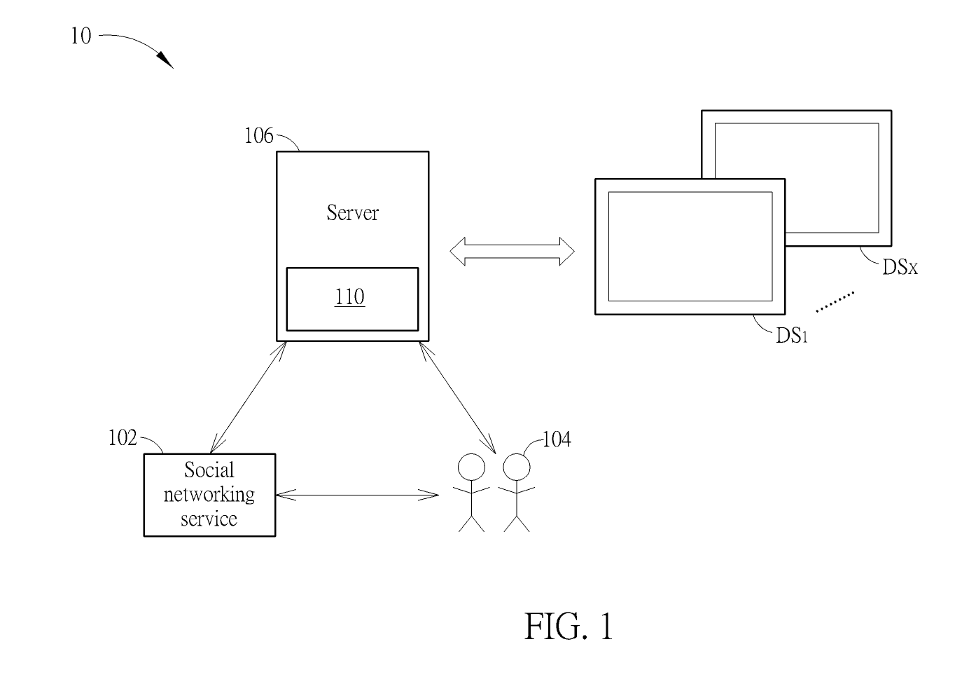

Please refer to FIG. 1, which is a schematic diagram of a network environment 10 according to an embodiment of the present invention. As shown in FIG. 1, the network environment 10 includes a social networking service 102, at least one user 104, a server 106 and DOOHs DS₁-DS_{X}. The network environment 10 may be a local, proprietary network (e.g. an intranet), and/or a part of a wide area network (WAN). The network environment 10 may also be a local area network (LAN), which may be communicatively coupled to a WAN such as the Internet. The network environment 10 may also be a combination of different types of networks; this is not limited herein. The spirit of the network environment 10 is to provide a platform for members of the network environment 10 to communicate with each other.

The social networking service 102 includes any social networking platforms with user location tagging functions (e.g. check-in). The social networking service 102 maybe Facebook, Google+, Twitter, Foursquare, Gowalla, GetGlue or Brightkite, etc. The user 104 may utilize any number of different electronic devices such as a mobile phone, smart phone, personal digital assistant (PDA), portable computer (e.g. laptop, netbook and tablet), personal computer (PC), etc., or any other types of communication devices which can be utilized in the network environment 10. Such communication devices utilized by the user 104 may possess positioning functionalities for executing location tagging. Through the above electronic devices, the user 104 may communicate with the social networking service 102 and the server 106 via the network environment 10, in order to obtain the check-in service. The server 106 includes a program 110, which is utilized for indicating a processor of the server 106 to execute the method of displaying personalized information on the DOOHs DS₁-DS_{X}. More specifically, the server 106 can be utilized for storing information related to the locations and displaying schedules of the DOOHs DS₁-DS_{X}, in order to display the check-in information of the user 104 on the DOOHs DS₁-DS_{X}. In some embodiments, the server 106 may be utilized for managing the displaying schedules of each of the DOOHs DS₁-DS_{X}.

The user 104 may use any devices with positioning functionalities in the electronic devices detailed above to find out their current location, and then share the location with friends via check-in, where the devices may comprise a global positioning system (GPS), near field communication (NFC), wireless radio frequency identification (RFID), etc. Common check-in landmarks are famous restaurants or tourist attractions, and the user 104 may display the check-in message on the social networking service 102. In the embodiments of the present invention, the outdoor digital billboard or video wall of the DOOHs DS₁-DS_{X} may also be considered as a landmark for check-in. When the user 104 checks in, in addition to being shared on the social networking service 102, the information related to check-in may also be delivered and shared by the DOOHs DS₁-DS_{X}.

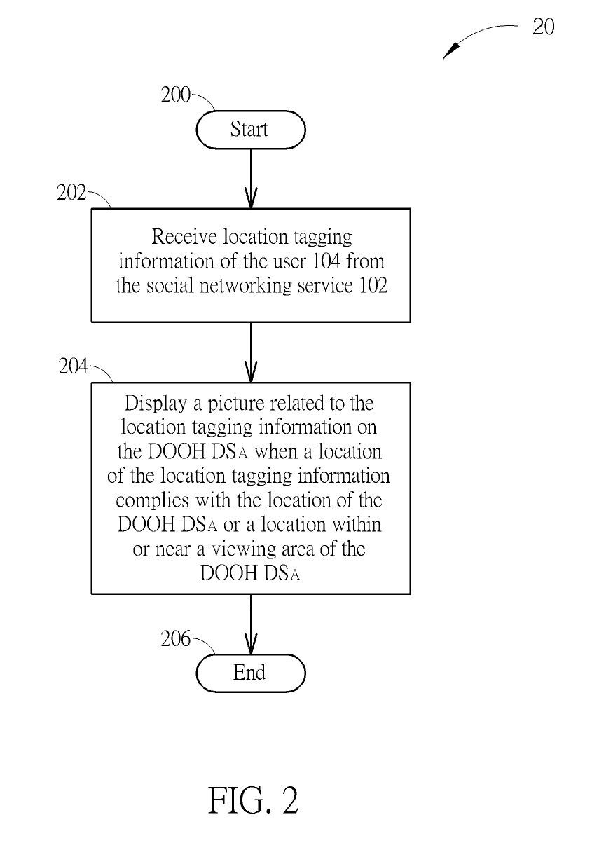

Please refer to FIG. 2, which is a schematic diagram of a process 20 according to an embodiment of the present invention. The process 20 can be compiled into the program 110 and realized in the server 106. The program 110 is utilized for indicating a processor to execute a method of displaying personalized information on the DOOHs DS₁-DS_{X}. The process 20 includes the following steps:

Step 200: Start.

Step 202: Receive location tagging information of the user 104 from the social networking service 102.

Step 204: Display a picture related to the location tagging information on the DOOH DS_{A} when a location of the location tagging information complies with the location of the DOOH DS_{A} or a location within or near a viewing area of the DOOH DS_{A}.

Step 206: End.

According to the process 20, when the user 104 uses the social networking service 102 for location tagging (e.g. check-in), the social networking service 102 may provide several locations for the user 104 to select. The selectable location may not only include restaurants or scenic spots, but also include the locations of the DOOHs DS₁-DS_{X}. After the user 104 selects the DOOH DS_{A} as a check-in location, the server 106 determines that the check-in location is the DOOH DS_{A} or the location within or near the viewing area of the DOOH DS_{A}, and controls the DOOH DS_{A} to play the content related to the check-in information. As a result, in addition to being displayed on the platform of the social networking service 102 (e.g. the Facebook wall), the check-in information may also be displayed on the video wall of the DOOH DS_{A}.

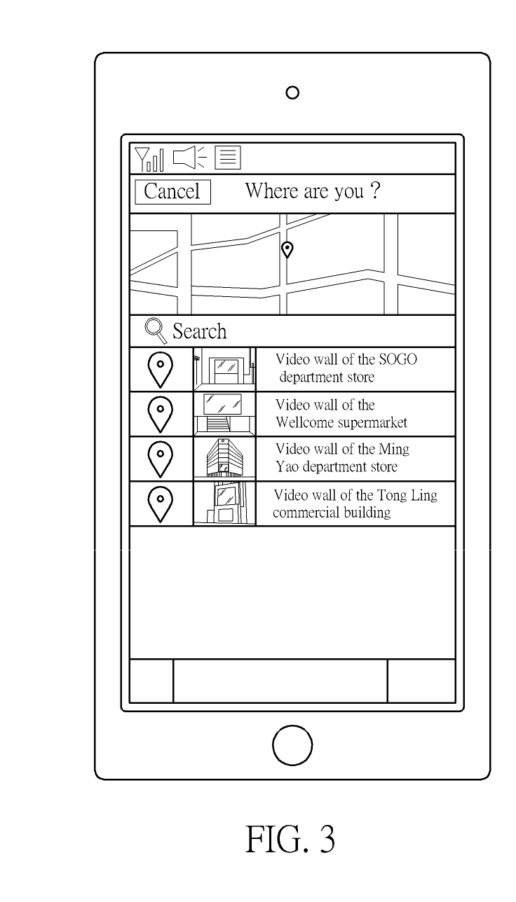

Please refer to FIG. 3, which is a schematic diagram of selecting the check-in location according to an embodiment of the present invention. As shown in FIG. 3, when the user 104 needs to check in, the social networking service 102 may obtain the location of the user 104 via devices with positioning functionalities such as a GPS, mobile communication networking positioning, NFC, RFID or Wi-Fi, and provide vicinal landmarks for the user to select as the check-in location. In FIG. 3, the social networking service 102 provides several landmarks corresponding to the DOOHs, such as the video wall of the SOGO department store, Zhong-Xiao Fuxing location, the video wall of the Wellcome supermarket, the video wall of the Ming Yao department store, and the video wall of the Tong Ling commercial building. In some embodiments, information such as the distances or check-in times related to these landmarks may also be displayed. These landmarks corresponding to the DOOHs maybe anyplace where a digital signage or video wall is set, such as a department store, scenic spot, plaza, etc. These landmarks may also be locations within or near the viewing areas of the digital signages or video walls, and are not limited herein.

In some embodiments, when the user 104 uses a landmark corresponding to the DOOH DS_{A} as the check-in location, the user 104 may directly deliver the check-in content to the social network. Such check-in content may include a text message or a photo taken at the check-in location. The user 104 may also select other photos or pictures as the check-in content, which is not limited herein. Similarly, the check-in content may also be delivered to the video wall of the DOOH DS_{A}. For example, the video wall may display a text message delivered by the user 104, a spot photo, other photo or picture of the user 104, head shot of the user 104 or information of the user 104, etc. As a result, the content played on the DOOH DS_{A} will no longer be boring commercial advertisement. Instead, it will be novel personalized content, which may attract more people to stop and look. For the user 104, such a check-in method provides a novel method for them to share their information with a wide audience, thereby expanding the current platform of “social networking”.

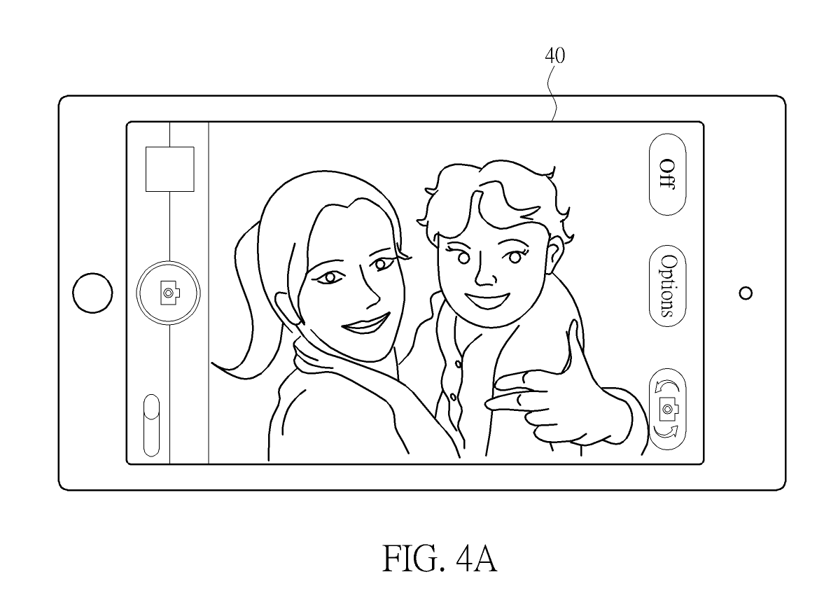

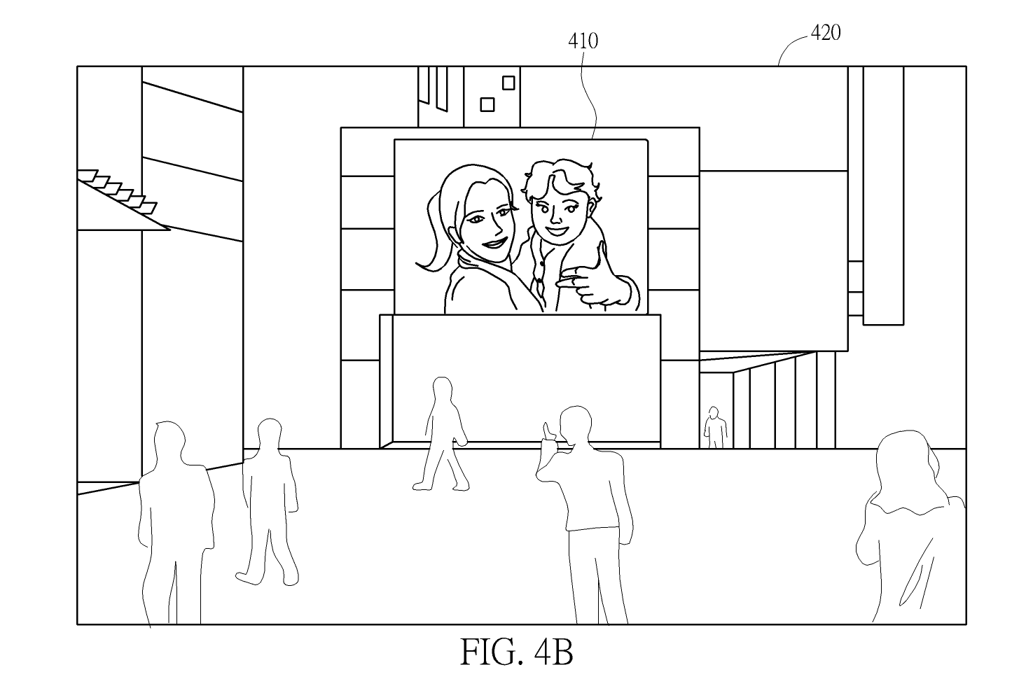

When the check-in message of the user 104 is displayed on the video wall of the DOOH DS_{A}, the user 104 may also want to deliver this message to relatives and friends. In some embodiments, the check-in content delivered by the user 104 on the platform of the social networking service 102 may be modified in order to send the message via the social networking platform. Please refer to FIG. 4A and FIG. 4B. FIG. 4A illustrates a photo 40 taken at a check-in location of the user 104 in the DOOH DS_{A}. When the user 104 checks in, the photo 40 is utilized as the check-in information and displayed on the video wall 410 of the DOOH DS_{A}. This is shown in FIG. 4B, which illustrates a scene picture 420, including the video wall 410 of the DOOH DS_{A} and its peripheral environment. In the scene picture 420, the video wall 410 displays the photo 40 of the user 104, which shows that the user 104 uses the DOOH DS_{A} as a landmark to check in. In some embodiments, a camera may be set in front of the video wall 410, in order to take a photo of the scene picture 420 including the video wall 410 and its peripheral environment when the video wall 410 displays the photo 40 of the user 104. This spot photo can then be uploaded to and delivered to the social networking service 102. In other embodiments, a video recorder may also be set in front of the video wall 410, in order to record the scene picture 420 including the video wall 410 and its peripheral environment for generating a video when the video wall 410 displays the photo 40 of the user 104. This video can then be uploaded to and delivered to the social networking service 102. In some embodiments, the user 104 may also upload other photos or pictures as the check-in content to be displayed on the video wall 410. This wider exposure ensures that the check-in content receives more attention.

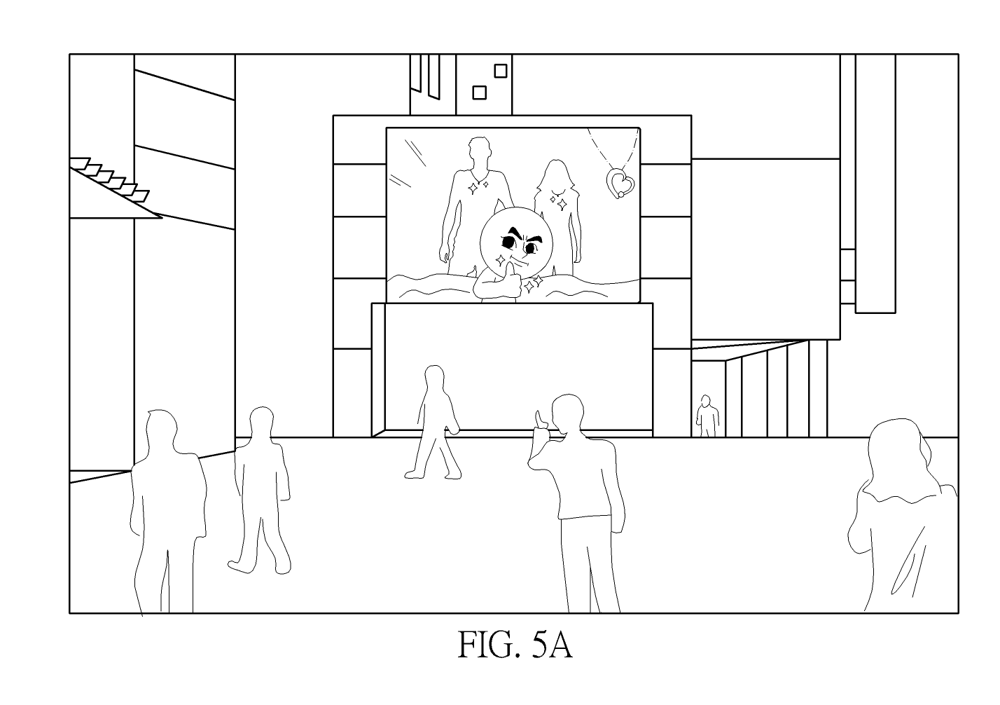

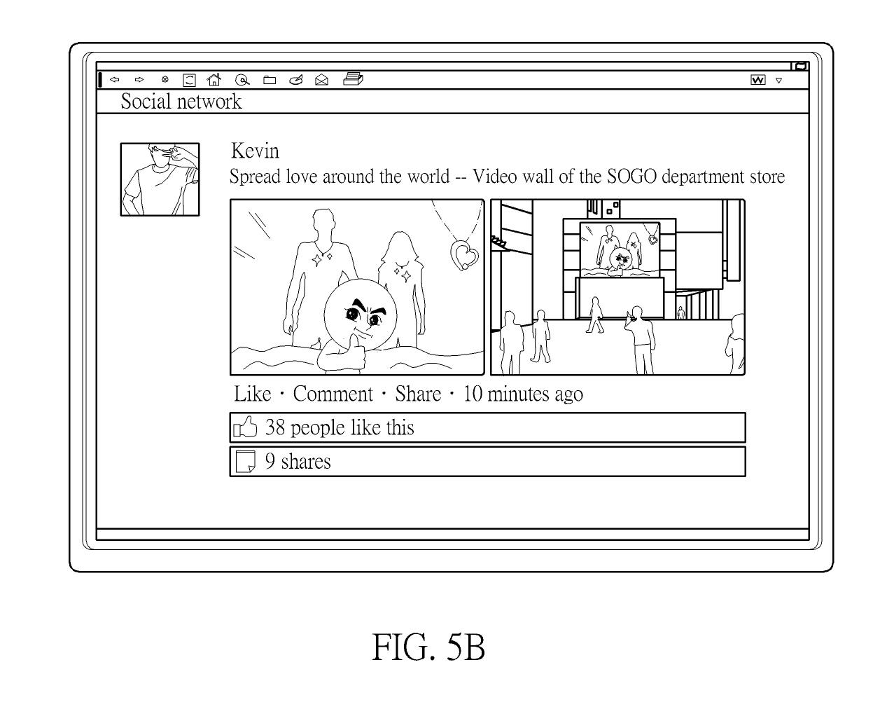

Please note that the check-in content played on the video wall of the DOOH may further be combined with commercial advertisements. For example, the photo uploaded by the user 104 may be included in a picture frame or added to a picture, and branded with a logo. Please refer to FIG. 5A and FIG. 5B. FIG. 5A is a schematic diagram of a DOOH displaying a spot photo combined with a commercial advertisement according to an embodiment of the present invention. As shown in FIG. 5A, an advertisement for gold ornaments places a background and a logo in the picture, and a photo of two lovers uploaded via check-in is inserted in the background. When the user 104 checks in, the photo and scene picture may also be delivered to the social networking platform, as shown in FIG. 5B. By including personalized content in the advertisement, the variety of advertisement content is increased, and the advertisement will receive more attention from the audience. The advertisement content may further be broadcast via the social networking platforms, in order to increase advertising effectiveness.

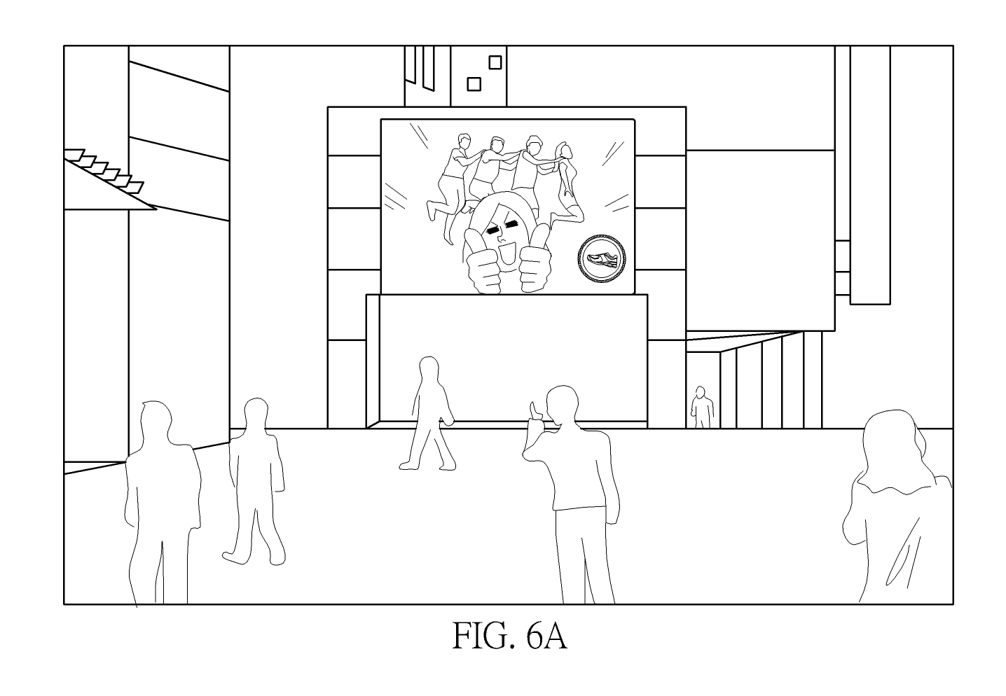

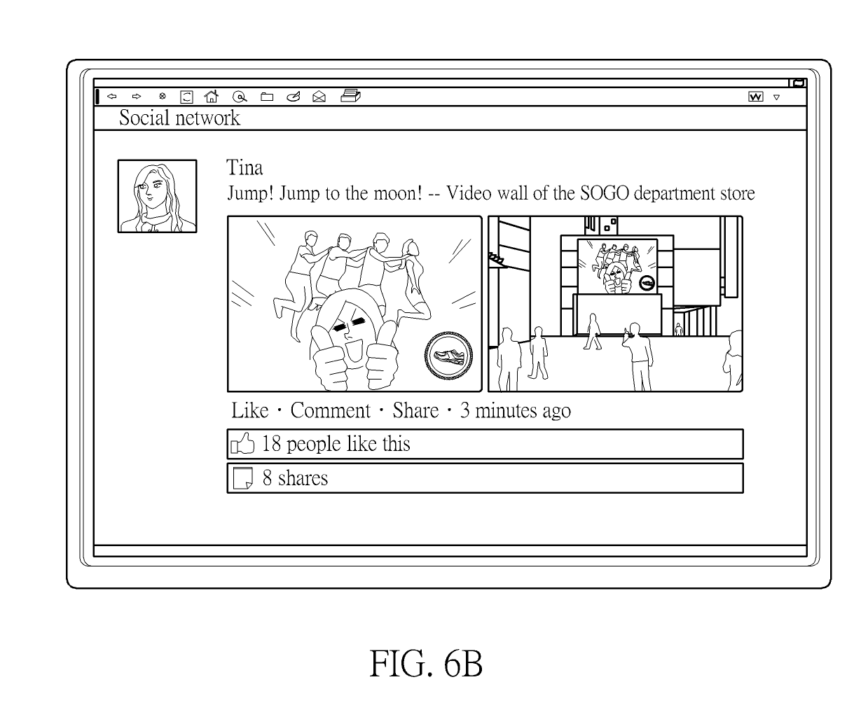

In an embodiment, a check-in theme may be inserted in a commercial advertisement, allowing the user 104 to use their creativity to adapt the advertisement. Please refer to FIG. 6A and FIG. 6B. FIG. 6A is a schematic diagram of another DOOH displaying a spot photo combined with a commercial advertisement according to an embodiment of the present invention. As shown in FIG. 6A, the advertisement for sport shoes asks the user 104 to upload a photo with people jumping when the user 104 checks in, and provides a gift as encouragement for the user 104. As before, when the user 104 checks in, the photo and scene picture may also be delivered to the social networking platform, as shown in FIG. 6B. The commercial advertiser may also provide a gift for the user who gets the most number of “likes” on the social networking platform. As each user will have a different creative idea, the content and the variety of the advertisement become richer. The interaction between the advertising content and the audience will also generate greater interest.

Please note that the present invention combines the check-in of the social networking platforms with the content displayed on the DOOH, where the location of the DOOH may be considered as a landmark for the user to check in, and the check-in content of the user may be displayed on the outdoor video wall or digital signage of the DOOH simultaneously. The scene picture in which the video wall displays the check-in content is also shared on the social networking platform. Those skilled in the art can make modifications and alterations accordingly. For example, the personalized content displayed on the video wall or digital signage and combined with a commercial advertisement as in the above embodiments may also be combined with other types of advertisements such as those for an exhibition or a dancing competition; this is not limited herein. The method of displaying the check-in pictures may be adapted to the video displaying mechanism of the DOOH via settings of playing frequency, number of check-ins played each time, playing time for each check-in, etc. The system may adjust the playing settings according to audience preference or requirements of the commercial advertiser.

The above embodiments of the present invention may be realized via a non-transitory computer-readable storage medium. The non-transitory computer-readable storage medium refers to any medium participating in providing instructions to a central processing unit (CPU) for execution. The media may take many forms, which include but are not limited to, non-volatile and volatile media such as optical or magnetic disks and dynamic memory. Common forms of computer-readable storage media include a floppy disk, a flexible disk, a hard disk, a magnetic tape, any other magnetic medium, a CD-ROM disk, a digital video disk (DVD), any other optical medium, a RAM, a PROM, an EPROM, a FLASHEPROM, and any other memory chip or cartridge.

The abovementioned DOOH refers to a digital medium which is not located in a home space. It usually displays the content by utilizing digital signage. The digital signage is usually a video wall installed on an outside wall of a building, which is not limited herein. The DOOH may also be any media which displays video content in a public area.

The abovementioned social networking service (SNS) refers to a service, platform or website capable of building social networks or social relations. The main function of the SNS is to set up an on-line society for a group of people having the same interest or engaging in the same activity. This kind of service is always performed via the Internet, and provides an approach for the user to perform many kinds of communication such as email, messenger, etc. The social networking website usually allows the user to share comments, activities, events, interests, etc. in his/her social network, which is not limited herein.

The abovementioned check-in refers to any people performing the functions of location tagging, area marking, destination indication or place labeling, etc. for the locations of themselves or others. When a specific location is utilized as a landmark for check-in, the tagged people may have been to this specific location. The location tagging is generally performed on the social networking services via a mobile device, in order to share the tagging information on the social networking platforms. The tagging landmark may be any location, which should not be limited to restaurants or tourist attractions.

In the prior art, although the DOOHs have the characteristics of “narrowcasting” and “crowd gathering”, the advertisements played on the DOOHs are often “commercial-oriented” rather than “content-oriented”. Very soon, people tire of watching them, and may ignore them eventually. Further, the check-in functionality provided by the social networking services are only limited to sharing on the social networking platforms, and are fairly monotonous. In comparison, the present invention combines the check-in functionality of the social network with the DOOH. Personalized check-in content may be played on the outdoor video wall, and the related picture may also be shared on the social networking platforms. Through this method, people will take more notice of both the advertising and check-in, which achieves more effective marketing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying personalized information on a digital out of home (DOOH) comprising:
receiving location tagging information of a user; and
displaying a picture related to the location tagging information on the DOOH when a location of the location tagging information complies with a location of the DOOH or a location within or near a viewing area of the DOOH.

2. The method of claim 1, wherein the location tagging information comprises a text message, a spot photo, a photo of the user, or user information stored in a social network.

3. The method of claim 1, wherein when the location of the location tagging information complies with the location of the DOOH or the location within or near the viewing area of the DOOH, the method further comprises:
modifying location tagging content of a user identifier corresponding to the user in a social network.

4. The method of claim 3, wherein the step of modifying the location tagging content of the user identifier corresponding to the user in the social network comprises:
obtaining a scene picture with the DOOH and peripheral content when the DOOH displays the picture related to the location tagging information; and
sending the scene picture to the social network, in order to deliver the scene picture to the social network.

5. The method of claim 4, wherein the step of obtaining the scene picture with the DOOH and peripheral content when the DOOH displays the picture related to the location tagging information comprises:
taking a photo of the scene picture by using a camera.

6. The method of claim 4, wherein the step of obtaining the scene picture with the DOOH and peripheral content when the DOOH displays the picture related to the location tagging information comprises:
recording a video comprising the scene picture by using a video recorder.

7. The method of claim 1, further comprising:
providing a plurality of DOOHs for a user to select as a tagging location according to a location of the user.

8. A system for displaying personalized information for a digital out of home (DOOH), the system comprising:
a memory, for storing a location of the DOOH;
a processor; and
a storage medium, having a program executable by the processor to perform the following steps:
receiving location tagging information of a user; and
displaying a picture related to the location tagging information on the DOOH when a location of the location tagging information complies with the location of the DOOH or a location within or near a viewing area of the DOOH.

9. The system of claim 8, wherein the location tagging information comprises a text message, a spot photo, a photo of the user, or user information stored in a social network.

10. The system of claim 8, wherein when the location of the location tagging information complies with the location of the DOOH or the location within or near the viewing area of the DOOH, the program is further executed by the processor to perform the following step:
modifying location tagging content of a user identifier corresponding to the user in a social network.

11. The system of claim 10, wherein the step of modifying the location tagging content of the user identifier corresponding to the user in the social network comprises:
obtaining a scene picture with the DOOH and peripheral content when the DOOH displays the picture related to the location tagging information; and
sending the scene picture to the social network, in order to deliver the scene picture to the social network.

12. The system of claim 11, wherein the step of obtaining the scene picture with the DOOH and peripheral content when the DOOH displays the picture related to the location tagging information comprises:
taking a photo of the scene picture by using a camera.

13. The system of claim 11, wherein the step of obtaining the scene picture with the DOOH and peripheral content when the DOOH displays the picture related to the location tagging information comprises:
recording a video comprising the scene picture by using a video recorder.

14. The system of claim 8, wherein the program is further executed by the processor to perform the following step:
providing a plurality of DOOHs for a user to select as a tagging location according to a location of the user.

15. A non-transitory computer-readable storage medium, having a program which is executable by a processor to perform a method of displaying personalized information on a digital out of home (DOOH), the method comprising:
receiving location tagging information of a user; and
displaying a picture related to the location tagging information on the DOOH when a location of the location tagging information complies with a location of the DOOH or a location within or near a viewing area of the DOOH.

16. The non-transitory computer-readable storage medium of claim 15, wherein the location tagging information comprises a text message, a spot photo, a photo of the user, or user information stored in a social network.

17. The non-transitory computer-readable storage medium of claim 15, wherein when the location of the location tagging information complies with the location of the DOOH or the location within or near the viewing area of the DOOH, the non-transitory computer-readable storage medium further comprises executable instructions for modifying location tagging content of a user identifier corresponding to the user in a social network.

18. The non-transitory computer-readable storage medium of claim 17, wherein the step of modifying the location tagging content of the user identifier corresponding to the user in the social network comprises:
obtaining a scene picture with the DOOH and peripheral content when the DOOH displays the picture related to the location tagging information; and
sending the scene picture to the social network, in order to deliver the scene picture to the social network.

19. The non-transitory computer-readable storage medium of claim 18, wherein the step of obtaining the scene picture with the DOOH and peripheral content when the DOOH displays the picture related to the location tagging information comprises:
taking a photo of the scene picture by using a camera.

20. The non-transitory computer-readable storage medium of claim 18, wherein the step of obtaining the scene picture with the DOOH and peripheral content when the DOOH displays the picture related to the location tagging information comprises:
recording a video comprising the scene picture by using a video recorder.

21. The non-transitory computer-readable storage medium of claim 15, further comprising executable instructions for providing a plurality of DOOHs for a user to select as a tagging location according to a location of the user.
